(19) United States
(12) Patent Application Publication
(10) Pub. No.: US 2025/0309246 A1
(43) Pub. Date: Oct. 2, 2025

(54) POSITIVE ELECTRODE PLATE AND LITHIUM-ION BATTERY USING POSITIVE ELECTRODE PLATE

(71) Applicant: EVE POWER CO., LTD., Jingmen (CN)

(72) Inventors: Qi HU, Jingmen (CN); Xinxin XU, Jingmen (CN); Chao WANG, Jingmen (CN); Hanmin ZENG, Jingmen (CN); Wei HE, Jingmen (CN)

(73) Assignee: EVE POWER CO., LTD., Jingmen (CN)

(21) Appl. No.: 18/991,748

(22) Filed: Dec. 23, 2024

(30) Foreign Application Priority Data
Apr. 2, 2024 (CN) 202410396103.8
May 6, 2024 (WO) PCT/CN2024/091225

(51) Int. Cl. H01M 4/36; H01M 4/02; H01M 4/505; H01M 4/525; H01M 4/58

(52) U.S. Cl. CPC H01M 4/366; H01M 4/364; H01M 4/505; H01M 4/525; H01M 4/5825; H01M 2004/021; H01M 2004/028

(57) ABSTRACT

The present disclosure provides a positive electrode plate and a lithium-ion battery using the positive electrode plate. The positive electrode plate includes a current collector and a positive electrode active material layer. The positive electrode active material layer includes a first active material layer and a second active material layer, both of which are provided in a composite manner. The first active material includes a lithium manganese oxide spinel material and a ternary material, and the second active material layer includes a phosphate material; single crystal sizes of the lithium manganese oxide spinel material and the ternary material are D₁ and D₂, respectively, which meet a condition D₂≥3.2*D₁.

### CROSS-REFERENCE TO RELATED APPLICATION

This application claims priority to and the benefit of Chinese Patent Application No. 202410396103.8, filed on Apr. 2, 2024, and International Application No. PCT/CN2024/091225, filed on May 6, 2024, the disclosures of which are incorporated herein by reference in their entireties.

### TECHNICAL FIELD

The present disclosure relates to the field of lithium-ion battery, and in particular to a positive electrode plate and a lithium-ion battery using the positive electrode plate.

### BACKGROUND

Lithium manganese iron phosphate material has better rate capability and low-temperature performance, but has a dual voltage platform, which makes the design of Battery Management System (BMS) more difficult. Therefore, the lithium manganese iron phosphate material is generally mixed with ternary materials for use to smooth the charge-discharge curve and improve the cycling stability, and thereby improving the cycling performance. Some researchers have proposed introducing lithium manganese oxide, which has a lower cost, and can be mixed with lithium manganese iron phosphate due to its higher applied voltage. By using the ternary materials with high energy density, low-cost lithium manganese oxide materials, and long-cycle lithium manganese iron phosphate materials in combination, a battery with long cycle life and low cost can be achieved.

However, in the related technologies, the three materials are generally mixed directly to form a slurry, which is then coated evenly, but due to significant differences in particle size, density, and pH value among the three materials, it is difficult to mix them, leading to a difficult in electrode plate processing. In addition, for the electrode plate obtained by mixing the three materials together, the distribution of the particles is uneven, failing to utilize the advantages of the three materials. There is also a method that the ternary material and the lithium manganese iron phosphate material are prepared as separate coatings and then a composite coating method is adopted. But in this method, a gap filling effect of the lithium manganese iron phosphate on the ternary material cannot be utilized, resulting in a decrease in compacted density; the cost reducing and energy density improving effects of the lithium manganese oxide, which is a simple blended material, cannot be fully achieved. Therefore, there is a need to develop a low cost and high compaction electrode system design that meets the requirements for energy density and cycling performance.

### SUMMARY

The present disclosure provides a positive electrode plate and a lithium-ion battery using the positive electrode plate, which can reduce the battery production cost, increase the compacted density of an electrode plate, and improve the volumetric energy density and cycling performance of the battery.

The present disclosure provides a positive electrode plate including a current collector and a positive electrode active material layer coated on at least one side of the current collector; the positive electrode active material layer includes a first active material layer and a second active material layer, both of which are provided in a composite manner; in which, the first active material includes a lithium manganese oxide spinel material and a ternary material; the second active material layer includes a phosphate material; the lithium manganese oxide spinel material includes a lithium manganese oxide single crystal particle, and the ternary material includes a ternary single crystal particle; a primary particle of the lithium manganese oxide spinel material is D₁, a primary particle of the ternary material is D₂, and a relationship between the lithium manganese oxide spinel material and the ternary material meets a condition D₂≥3.2*D₁.

The present disclosure also provides a lithium-ion battery comprising the positive electrode plate described above.

### BRIEF DESCRIPTION OF DRAWINGS

FIG. 1 shows a positive electrode plate provided by some embodiments of the present disclosure, in which a first active material layer is provided on a side close to a current collector.

FIG. 2 shows the positive electrode plate provided by some embodiments of the present disclosure, in which a second active material layer is provided on a side close to the current collector.

### DETAILED DESCRIPTION

In order to make those skilled in the art better understand the technical solution in the present disclosure, the technical solution in the present disclosure is illustrated clearly and completely in combination with the examples and the drawings of the examples below. Obviously, the described examples are only a part of the examples in the present disclosure, not all of the examples.

### Example 1

### 1. Preparation of a Positive Electrode Plate

### (1) Preparation of Materials for Preparing the Positive Electrode Plate

For preparing the positive electrode plate provided in this example, the optional positive electrode active materials of each active material layer are shown in Table 1. Particularly, D₃ of phosphate material LiMn_{0.6}Fe_{0.4}PO₄ is 200 nm.

TABLE 1
Materials for Preparing the Positive Electrode Plate

| Positive Electrode Active | Positive Electrode | |
|---|---|---|
| Material Layer | Active Material | |
| first active material | ternary material | LiNi_{0.8}Co_{0.1}Mn_{0.1}O₂ |
| layer | | LiNi_{0.8}Co_{0.1}Al_{0.1}O₂ |
| | lithium manganese oxide | LiMn₂O₄ |
| | spinel material | |
| second active material | phosphate material | LiMn_{0.6}Fe_{0.4}PO₄ |
| layer | | |

### A Method for Preparing the Positive Electrode Plate

The lithium manganese oxide spinel material and the ternary material shown in Table 1 are mixed at a mass ratio of 1:1. Then, an obtained mixed material, conductive carbon black, CNT and PVDF are mixed at a mass ratio of 96:1:1:2. After mixing and stirring these materials evenly using NMP as a solvent, a first active material layer slurry is obtained.

The phosphate material shown in Table 1, the conductive carbon black, CNT and PVDF are mixed in the mass ratio of 96:1:1:2. After mixing and stirring these materials evenly using NMP as the solvent, a second active material layer slurry is obtained.

The first active material layer slurry and the second active material layer slurry are coated on a carbon-coated aluminum foil at the same time, in which, the first active material layer is provided on a side close to an aluminum foil, with a surface density of 40 g/m²; a surface density of the second active material layer is 160 g/m². After drying, cold pressing (with an electrode plate extension rate of 0.5-0.7%) and die-cutting, the positive electrode plate is obtained.

### 2. Preparation of a Negative Electrode Plate

A slurry prepared using a negative electrode material (graphite), conductive agent (acetylene black), adhesive (CMC and SBR) at a mass ratio of 94:1:2:3 is coated on a copper foil current collector. After vacuum drying, a negative electrode plate is obtained.

### 3. Assembly of a Battery

The positive electrode plate prepared above, a separator (a 14 μm separator from Semcorp is selected) and the negative electrode plate are stacked in order, with the separator serving as an isolator between the positive electrode plate and the negative electrode plate, and then a cell is obtained by stacking or winding. The cell is provided in an outer packaging shell (such as an aluminum shell or a soft package), after drying, an electrolyte is added (ZP507 type from Sinochem Lantian Co., Ltd. is selected) at a ratio of 5.0 g/Ah. After vacuum packaging, standing, formation, and capacity grading, a secondary battery for testing is obtained.

In this example, the positive electrode active materials selected for preparing the first active material layer and the second active material layer, along with their primary particle sizes, are taken as variables, and different treatment groups and control groups are set up. In particular, in Example 1, the variables for treatment groups 1A-4A and control groups 1A-2A are shown in Table 2. Except for the aforementioned differences, steps for preparing the positive electrode plate and a lithium-ion battery in this example are consistent with the methods described above.

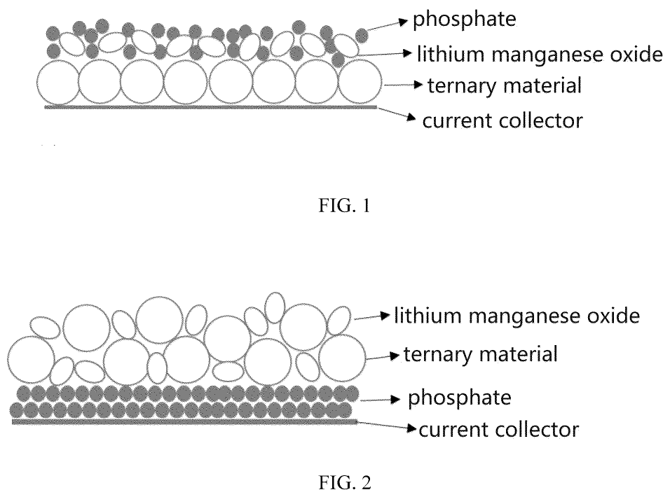

The positive electrode plate prepared from Treatment Group 1A of Example 1 is shown in FIG. 1, and the positive electrode plate prepared from Treatment Group 5A of Example 1 is shown in FIG. 2

TABLE 2
Variables for Treatment Groups 1A-4A and Control Groups 1A-2A in Example 1

| | Electrode Layer | | | | | | |
|---|---|---|---|---|---|---|---|
| | First Active Material Layer | | | | | | Second active |
| | (close to aluminum foil) | | | | | | Material Layer |
| | Positive Electrode | | | Positive Electrode | | | Positive Electrode |
| Groups | Active Material | D₂ | | Active Material | D₁ | | Active Material |
| Treatment | LiNi_{0.8}Co_{0.1}Mn_{0.1}O₂ | 3 | μm | LiMn₂O₄ | 0.5 | μm | LiMn_{0.6}Fe_{0.4}PO₄ |
| Group 1A | | | | | | | |
| Treatment | LiNi_{0.8}Co_{0.1}Mn_{0.1}O₂ | 5 | μm | LiMn₂O₄ | 1.5 | μm | LiMn_{0.6}Fe_{0.4}PO₄ |
| Group 2A | | | | | | | |
| Treatment | LiNi_{0.8}Co_{0.1}Mn_{0.1}O₂ | 6.6 | μm | LiMn₂O₄ | 1.5 | μm | LiMn_{0.6}Fe_{0.4}PO₄ |
| Group 3A | | | | | | | |
| Treatment | LiNi_{0.8}Co_{0.1}Mn_{0.1}O₂ | 6.6 | μm | LiMn₂O₄ | 2 | μm | LiMn_{0.6}Fe_{0.4}PO₄ |
| Group 4A | | | | | | | |
| Control | LiNi_{0.8}Co_{0.1}Mn_{0.1}O₂ | 1 | μm | LiMn₂O₄ | 3 | μm | LiMn_{0.6}Fe_{0.4}PO₄ |
| Group 1A | | | | | | | |
| Control | LiNi_{0.8}Co_{0.1}Mn_{0.1}O₂ | 2 | μm | LiMn₂O₄ | 1.5 | μm | LiMn_{0.6}Fe_{0.4}PO₄ |

Group 2A

### Treatment Group 5A

In this treatment group, the positive electrode plate is prepared according to a formulation provided in Treatment Group 1A of Example 1. A difference between this treatment group and Treatment Group 1A of Example 1 lies in that the second active material layer slurry is coated on a side close to the aluminum foil when preparing the positive electrode plate. Except for the aforementioned differences, the preparation of the lithium-ion battery in this treatment group is strictly consistent with that of Treatment Group 1A in Example 1. Particularly, for the second active material layer close to the aluminum foil, the positive electrode active material used is LiMn_{0.6}Fe_{0.4}PO₄ with D₃ of 200 nm; for the first active material layer away from the aluminum foil, the positive electrode active materials used are LiMn₂O₄ with D₁ of 0.5 μm and LiNi_{0.8}Co_{0.1}Mn_{0.1}O₂ with D₂ of 3 μm.

### Control Group 3A

In this control group, the positive electrode plate is prepared according to the formulation provided in Treatment Group 1A of Example 1. The difference between this control group and Treatment Group 1A of Example 1 lies in that, when preparing the positive electrode plate, the material used for the first active material layer only is NCM811, and the second active material layer is prepared by mixing a lithium manganese iron phosphate material and a lithium manganese oxide material together. Except for the aforementioned differences, the preparation of the lithium-ion battery in this control group is strictly consistent with that of Treatment Group 1A in Example 1. Particularly, for the first active material layer close to the aluminum foil, the positive electrode active material used is LiNi_{0.8}Co_{0.1}Mn_{0.1}O₂ with D₂ of 3 μm; for the second active material layer away from the aluminum foil, the positive electrode active materials used are LiMn₂O₄ with D₁ of 0.5 μm and LiMn_{0.6}Fe_{0.4}PO₄ with D₃ of 200 nm.

### Control Group 4A

In this control group, the positive electrode plate is prepared according to the formulation provided in Treatment Group 1A. The Difference between this control group and Treatment Group 1A lies in that, when preparing the positive electrode plate, the material used for the first active material layer is NCM811, and the material used for the second active material layer is lithium manganese iron phosphate. Except for the aforementioned differences, the preparation of the lithium-ion battery in this control group is strictly consistent with that of Treatment Group 1A in Example 1. Particularly, for the first active material layer close to the aluminum foil, the positive electrode active material used is LiNi_{0.8}Co_{0.1}Mn_{0.1}O₂ with D₂ of 3 μm; for the second active material layer away from the aluminum foil, the positive electrode active materials used are LiMn₂O₄ with D₁ of 0.5 μm and LiMn_{0.6}Fe_{0.4}PO₄ of D₃ of 200 nm.

### Control Group 5A

In this control group, the positive electrode plate is prepared according to the formulation provided in Treatment Group 1A of Example 1. The difference between this control group and Treatment Group 1A lies in that, when preparing the positive electrode plate, the material used for the first active material layer is NCM811, and the material used for the second active material layer is lithium manganese oxide material. Except for the aforementioned differences, the preparation of the lithium-ion battery in this control group is strictly consistent with that of Treatment Group 1A in Example 1. Particularly, for the first active material layer close to the aluminum foil, the positive electrode active material used is LiNi_{0.8}Co_{0.1}Mn_{0.1}O₂ with D₂ of 3 μm; for the second active material layer away from the aluminum foil, the positive electrode active material used is LiMn₂O₄ with D₁ of 0.5 μm.

### Control Group 6A

In this control group, the positive electrode plate is prepared according to the formulation provided in Treatment Group 1A of Example 1. The difference between this control group and Treatment Group 1A of Example 1 lies in that, in this control group, there is only one active material layer obtained by mixing NCM811 and the lithium manganese iron phosphate material together when preparing the positive electrode plate. In particular, a surface density ratio of NCM811 to lithium manganese iron phosphate material is 2:8. Except for the aforementioned differences, the preparation of the lithium-ion battery in this control group is strictly consistent with that of Treatment Group 1A in Example 1. Particularly, for the active material layer, the positive electrode active materials used are LiNi_{0.8}Co_{0.1}Mn_{0.1}O₂ with D₂ of 3 μm and LiMn_{0.6}Fe_{0.4}PO₄ with D₃ of 200 nm.

### Control Group 7A

In this control group, the positive electrode plate is prepared according to the formulation provided in Treatment Group 1A of Example 1. The difference between this control group and Treatment Group 1A of Example 1 lies in that, in this control group, there is only one active material layer obtained by mixing NCM811, the lithium manganese iron phosphate and the lithium manganese oxide together when preparing the positive electrode plate. Except for the aforementioned differences, the preparation of the lithium-ion battery in this control group is strictly consistent with that of Treatment Group 1A in Example 1. Particularly, for the active material layer, the positive electrode active materials used are LiMn₂O₄ with D₁ of 0.5 μm, LiNi_{0.8}Co_{0.1}Mn_{0.1}O₂ with D₂ of 3 μm and LiMn_{0.6}Fe_{0.4}PO₄ with D₃ of 200 nm. Specifically, steps for preparing the electrode plate in this control group are as follows: the lithium manganese oxide spinel material (LiMn₂O₄), the ternary material (LiNi_{0.8}Co_{0.1}Mn_{0.1}O₂) and the phosphate material (LiMn_{0.6}Fe_{0.4}PO₄) are mixed at a mass ratio of 1:1:1; a mixed positive electrode active material, the conductive carbon black, CNT and PVDF are then mixed at the mass ratio of 96:1:1:2; the positive electrode active material layer slurry is obtained after mixing and stirring these materials evenly using NMP as the solvent; the positive electrode active material layer slurry is then coated on the surface of aluminum foil; and after drying, cold pressing and die-cutting, the positive electrode plate is obtained.

### Test Example 1

### 1. Test Object

The batteries prepared in each treatment group and the control group of Example 1

### 2. Test Method

Cycling performance at room temperature: at 25° C., the lithium-ion battery is charged at a constant current of 0.5C (nominal capacity) to a voltage of 4.2V, then charged at a constant voltage of 4.2V until a current drops to no more than 0.05C. After a 10 min rest, the battery is discharged at a constant current of 1C or 2C until a cutoff voltage reaches 2.5V. The above is one charge-discharge cycle. The lithium-ion batteries are subjected to the charge-discharge cycles according to the above conditions at 25° C. respectively, and the number of cycles with a capacity retention of 80% at different discharge rates are recorded. In particular, the capacity retention is calculated according to Equation (1).

$$Capacity retention of lithium - ion battery after N times cycles ( \% ) = ( discharge capacity of Nth cycle / first discharge capacity ) \times 100 \%$$

### 3. Test Results and Analysis

The test results of this test example are shown in Table 3. Particularly, this test example primarily explores an effect of using different lithium manganese oxide spinel materials, ternary materials, phosphate materials, and a setting of the first active material layer and the second active material layer on the prepared positive electrode plate. In Treatment Groups 1A-4A of Example 1, the main focus is on exploring an effect of different D₁ and D₂, and the ternary material. Among them, the battery prepared in Treatment Group 1A shows excellent rate capability and cycling performance. However, comparing Treatment Group 5A with Treatment Group 1A, two positive electrode active layers are exchanged, yet an electrical performance of the lithium-ion battery prepared in Treatment Group 5A remains at a good level.

In Control Groups 1A-2A, the condition D₂≥3.2*D₁ is not met, leading to a decrease in the cycling performance of the batteries prepared in these groups.

In Control Group 3A, the first active material layer is the ternary material, the second active material layer is a mixture of the lithium manganese iron phosphate material and the lithium manganese oxide material, leading to a significant decrease in the rate capability and the cycling performance of the battery prepared in this group. Compared with Control Group 3A, in Control Group 4A, the second active material layer is the electrode plate prepared using only lithium manganese iron phosphate, leading to a significant decrease in the cycling performance of the battery prepared in this group.

In Control Group 5A, both of the ternary material and the lithium manganese oxide material are used for coating to prepare the electrode plate, leading to a significantly decrease in the rate capability and the cycling performance of the battery prepared in this group.

In Control Group 6A, the ternary material and the phosphate material are mixed for coating to prepare the electrode plate, leading to a significantly decrease in the rate capability of the battery prepared in this group. This may be because a dispersibility of the slurry obtained by mixing the phosphate material with lithium manganese oxide is not good as a dispersibility of the slurry obtained by mixing the ternary material with the lithium manganese oxide material.

In Control Group 7A, the positive electrode plate is prepared by mixing the lithium manganese oxide spinel material, the ternary material and the phosphate material together and then coating the resulting slurry. However, the positive electrode active slurry prepared by this method is difficult to mix evenly, leading to a significant decrease in the rate capability and cycling performance of the lithium-ion battery prepared in this group.

TABLE 3
Test Results of Test Example 1

| | Compacted | Rate Capability and Cycling | |
|---|---|---|---|
| | Density | Performance/Number of Cycles | |
| Groups | g/cm³ | 1 C | 2 C |
| Treatment Group 1A | 2.492 | 1913 | 1721 |
| Treatment Group 2A | 2.488 | 1794 | 1553 |
| Treatment Group 3A | 2.480 | 1854 | 1547 |
| Treatment Group 4A | 2.479 | 1810 | 1490 |
| Treatment Group 5A | 2.492 | 1902 | 1530 |
| Control Group 1A | 2.399 | 1589 | 1410 |
| Control Group 2A | 2.425 | 1705 | 1545 |
| Control Group 3A | 2.459 | 1689 | 1493 |
| Control Group 4A | 2.410 | 1739 | 1387 |
| Control Group 5A | 2.988 | 1118 | 1043 |
| Control Group 6A | 2.520 | 1605 | 1242 |
| Control Group 7A | 2.470 | 1514 | 1187 |

### Example 2

In this example, Treatment Groups 1B-5B are set up based on Treatment Group 2A in Example 1. Additionally, for Treatment Groups 1B-5B in Example 2, m₁ and ρ₁ of the first active material layer, and m₂ and ρ₂ of the second active material layer are taken as variables. Except for the aforementioned differences, the steps for preparing the positive electrode plate and lithium-ion battery of Treatment Groups 1B-5B in Example 2 are strictly consistent with those of Treatment Groups 2A in Example 1.

TABLE 4
Variables for Treatment Groups 1A-2A in Example 2

| Groups | m₁ | ρ₁ (g/cm³) | m₂ | ρ₂ (g/cm³) | $ρ = 1 / ( \frac{{m}_{1}}{{ρ}_{1}} + \frac{{m}_{2}}{{ρ}_{2}} )$ |
|---|---|---|---|---|---|
| Treatment | 0.1 | 2.6 | 0.9 | 2 | 2.05 |
| Group 1B | | | | | |
| Treatment | 0.5 | 2.9 | 0.5 | 2.5 | 2.69 |
| Group 2B | | | | | |
| Treatment | 0.5 | 3.8 | 0.5 | 1.9 | 2.53 |
| Group 3B | | | | | |
| Treatment | 0.7 | 3.2 | 0.3 | 2.3 | 2.86 |
| Group 4B | | | | | |
| Treatment | 0.9 | 3.2 | 0.1 | 2.3 | 3.08 |
| Group 5B | | | | | |

### Test Example 2

### 1. Test Object

The batteries prepared in each treatment group of Example 2.

### 2. Test Method

This example is conducted referring to Test Example 1.

### 3. Test Results and Analysis

The test results of this test example are shown in Table 5. Particularly, this test example primarily explores an effect of compacted density and mass fraction of the first active material layer and the second active material layer on the prepared positive electrode plate. Through testing data, it can be found that in Treatment Groups 1B to 5B, by adjusting the mass fraction and compact density of the first active material layer and the second active material layer, the compacted density of the positive electrode plate can be further optimized, thereby increasing the volumetric energy density and cycling performance of the positive electrode.

TABLE 5
Test Results of Test Example 2

| | Compacted | Rate Capability and Cycling | |
|---|---|---|---|
| | Density | Performance/Number of Cycles | |
| Groups | g/cm³ | 1 C | 2 C |
| Treatment Group 1B | 2.05 | 1912 | 1221 |
| Treatment Group 2B | 2.69 | 1694 | 1310 |
| Treatment Group 3B | 2.53 | 1642 | 1363 |
| Treatment Group 4B | 2.86 | 1545 | 1403 |
| Treatment Group 5B | 3.08 | 1510 | 1462 |

What is claimed is:

1. A positive electrode plate comprising a current collector and a positive electrode active material layer coated on at least one side of the current collector;
wherein the positive electrode active material layer comprises a first active material layer and a second active material layer, both of which are provided in a composite manner, wherein the first active material comprises a lithium manganese oxide spinel material and a ternary material; the second active material layer comprises a phosphate material;
the lithium manganese oxide spinel material comprises lithium manganese oxide single crystal particles, and the ternary material comprises ternary single crystal particles; a primary particle size of the lithium manganese oxide spinel material is D₁, a primary particle size of the ternary material is D₂, and the lithium manganese oxide spinel material and the ternary material meet a condition D₂≥3.2*D₁.

2. The positive electrode plate according to claim 1, wherein the primary particle size of the lithium manganese oxide spinel material D₁ is 0.5-2 μm.

3. The positive electrode plate according to claim 1, wherein the ternary material comprises at least one of LiNi_{0.8}Co_{0.1}Mn_{0.1}O₂ and LiNi_{0.8}Co_{0.1}Al_{0.1}O₂; the lithium manganese oxide spinel material comprises LiMn₂O₄; and the phosphate material comprises LiMn_{0.6}Fe_{0.4}PO₄.

4. The positive electrode plate according to claim 3, wherein the ternary material is LiNi_{0.8}Co_{0.1}Mn_{0.1}O₂ with D₂ of 3 μm, and the lithium manganese oxide spinel material is LiMn₂O₄ with D₁ of 0.5 μm.

5. The positive electrode plate according to claim 1, wherein a primary particle size of the phosphate material is D₃, and D₃ is 100 nm-600 nm.

6. The positive electrode plate according to claim 5, wherein the phosphate material is LiMn_{0.6}Fe_{0.4}PO₄ with D₃ of 200 nm.

7. The positive electrode plate according to claim 1, wherein in the positive electrode active material layer, a mass fraction of the first active material layer is m₁, and a compacted density of the first active material layer is ρ₁; a mass fraction of the second active material layer is m₂, and a compacted density of the second active material layer is ρ₂; the positive electrode plate meets the following relationships:
$${D}_{2} \geq 3.2 * {D}_{1} ; {m}_{1} : {m}_{2} = 0.1 - 10 : 1 , and {m}_{1} + {m}_{2} = 1.$$

8. The positive electrode plate according to claim 7, wherein in the first active material layer, a mass ratio of the lithium manganese oxide spinel material to ternary material is 0.1-5:1.

9. The positive electrode plate according to claim 7, wherein the compacted density ρ₁ of the first active material layer is 2.9-3.8 g/cm³, and/or the compacted density ρ₂ of the second active material layer is 2.0-2.5 g/cm³.

10. The positive electrode plate according to claim 9, wherein the mass fraction m₁ of the first active material layer is 0.9, and the compacted density ρ₁ of the first active material layer is 3.2 g/cm³; the mass fraction m₂ of the second active material layer is 0.1, and the compacted density ρ₂ of the second active material layer is 2.3 g/cm³.

11. The positive electrode plate according to claim 9, wherein a compacted density ρ of the positive electrode plate is 2.3-3.6 g/cm³.

12. The positive electrode plate according to claim 7, wherein a ratio of a surface density of the first active material layer to a surface density of the second active material layer is 5-60:50-200.

13. The positive electrode plate according to claim 12, wherein the surface density of the first active material layer is 5-60 g/m².

14. The positive electrode plate according to claim 13, wherein the surface density of the first active material layer is 40 g/m², and the surface density of the second active material layer is 160 g/m².

15. The positive electrode plate according to claim 1, wherein the first active material layer is coated on a side close to the current collector, and the second active material layer is coated on a side of the first active material layer away from the current collector.

16. The positive electrode plate according to claim 1, wherein the second active material layer is coated on a side close to the current collector, and the first active material layer is coated on a side of the second active material layer away from the current collector.

17. A lithium-ion battery comprising the positive electrode plate, wherein the positive electrode plate comprises a current collector and a positive electrode active material layer coated on at least one side of the current collector;
the positive electrode active material layer comprises a first active material layer and a second active material layer, both of which are provided in a composite manner, wherein the first active material comprises a lithium manganese oxide spinel material and a ternary material; the second active material layer comprises a phosphate material;
the lithium manganese oxide spinel material comprises lithium manganese oxide single crystal particles, and the ternary material comprises ternary single crystal particles; a primary particle size of the lithium manganese oxide spinel material is D₁, a primary particle size of the ternary material is D₂, and the lithium manganese oxide spinel material and the ternary material meet a condition D₂≥3.2*D₁.

18. The lithium-ion battery according to claim 17, wherein the primary particle size of the lithium manganese oxide spinel material D₁ is 0.5-2 μm.

19. The lithium-ion battery according to claim 17, wherein the ternary material comprises at least one of LiNi_{0.8}Co_{0.1}Mn_{0.1}O₂ and LiNi_{0.8}Co_{0.1}Al_{0.1}O₂; the lithium manganese oxide spinel material comprises LiMn₂O₄; and the phosphate material comprises LiMn_{0.6}Fe_{0.4}PO₄.

20. The lithium-ion battery according to claim 17, wherein the ternary material is LiNi_{0.8}Co_{0.1}Mn_{0.1}O₂ with D₂ of 3 μm, and the lithium manganese oxide spinel material is LiMn₂O₄ with D₁ of 0.5 μm.
